(19) United States
(12) Patent Application Publication
(10) Pub. No.: US 2010/0116519 A1
(43) Pub. Date: May 13, 2010

(54) POWER SCREWDRIVER

(76) Inventor: Marc Gareis, Leonberg (DE)

Correspondence Address: COLLARD & ROE, P.C., 1077 NORTHERN BOULEVARD, ROSLYN, NY, 11576, US

(21) Appl. No.: 12/451,013

(22) PCT Filed: Apr. 23, 2008
(86) PCT No.: PCT/DE2008/000671

§ 371 Date: Nov. 20, 2009

(30) Foreign Application Priority Data
Apr. 23, 2007 (DE) 10 2007 019 409.0

(51) Int. Cl. B25B 23/147; B25B 21/00

(52) U.S. Cl. 173/176; 173/217

(57) ABSTRACT

The invention relates to a power screwdriver (10) comprising a motor (12) as the drive, a desired torque default element (52) and an actual torque determination element (46), a torque gradient determination element (48) and a motor control (40) which controls the motor (12) depending on the torque gradient (dmd_lst/dt). The invention is characterized by a torque threshold determination element (50) which provides a torque threshold value (Md_Lim, Md_Lim1, Md_Lim2) that depends on the torque gradient (dmd_lst/dt) and lies below the desired torque value (Md_Soll). If the actual torque value (md_Ist) exceeds the torque threshold value (Md_Lim, Md_Lim1, Md_Lim2), a motor control (40) presets a speed reduction for the motor (12) or already completely switches off the motor (12). The power screwdriver (10) according to the invention avoids torque overshoots and yet allows the desired torque value (Md_Soll) to be exactly reached in the shortest time possible.

The invention starts from a power screwdriver according to the generic part of the independent claim.

### PRIOR ART

DE 23 26 027 A describes a mains voltage-operated screwdriver which provides a specified desired torque value. The torque applied by the screwdriver is directly detected based on the current flowing through the electric motor. Owing to the mains connection, an operating voltage of the electric motor is assumed that is at all times the same and constant. If the desired torque value has not yet been reached, the screwdriver rotates at the maximum possible speed which is dependent on the desired torque value to be applied. Owing to the mass inertia of the rotating parts of the screwdriver, such as the electric motor and in particular the gear mechanism, the screwed connection still continues to be rotated as a function of the after-run after the desired torque value has been reached.

The problems occurring in DE 23 26 027 A1 owing to the continued rotation of the screwdriver when the desired torque value has been reached are taken up by DE 103 41 975 A1. An electronic torque limiting device is described for an electric motor used, for example, in a battery-operated screwdriver. The starting point is an electronic torque limitation element in which the current flowing through the electric motor is adduced as a measure of the torque. A procedure of this type is described as being inaccurate because, in particular at high speeds, the kinetic energy of the rotating masses, after the electric motor has been switched off, can cause an after-run with the consequence that a screwed connection having a higher torque than the specified desired torque value is adduced. In order to avoid the torque peak, which is based on the mass inertia or the dynamics of the gear mechanism, it is proposed that the maximum value of the admissible electric motor current be defined as a function of the speed of the electric motor. According to one exemplary embodiment, a desired torque value may be defined that is converted to a maximum value of the electric motor current. The higher the maximum value of the electric motor current is set, the lower the maximum speed of the electric motor may become.

EP 0 187 353 A2 describes a screwdriver, the electric motor of which is supplied by the alternating voltage network. The starting point is the finding that the electric motor provides a maximum and determined torque under load while stationary, this torque being dependent on the provided voltage or the load current in accordance with the respective characteristic curve. The desired torque value of the screw joint is reached at a low speed of the screwdriver or even when the screwdriver is stationary, so that an overshoot of the desired torque value is prevented by an after-run.

A compensation circuit is also provided that is able to compensate for fluctuations of the mains voltage in order to eliminate the influence on the actual torque value. If the supply voltage falls, the phase gating angle of a triac activator is increased in size, so that a higher average voltage is applied to the electric motor.

DE 196 26 731 A1 describes a small, battery-operated screwdriver containing a switching element which switches off the electric motor by short-circuiting. The switching element is actuated by a depth stop. An overshoot is avoided as a result of the abrupt braking of the electric motor. However, it must in this case be borne in mind that such short-circuiting of the electric motor is possible only at comparatively low torques to be delivered, of up to for example 100 Nm, and in inefficient electric motors, as, even in inefficient electric motors, allowance must be made, in the case of short-circuiting of an electric motor rotating at high speed, for a considerable short-circuit current and the electromagnetic disturbances associated therewith. The short-circuit current places considerable stress both on a collector of an electric motor embodied as a DC motor and on the switching element used for short-circuiting the electric motor.

DE 103 45 135 A1 describes a small, battery-operated screwdriver containing a lithium ion battery for supplying energy.

DE 201 13 184 U1 and for example DE 196 47 813 A1 disclose screwdrivers which are configured as hand-held power tools, are driven by an electric motor and each have a supporting arm for providing a counter-torque during tightening or releasing of screwed connections.

Screwdrivers of this type are referred to as power screwdrivers because the torque provided may be up to, for example, 10,000 Nm; such a torque could not be applied by an operator of the power screwdriver without the supporting arm. As the torque increases during the screwing process, the supporting arm is elastically deformed, as a result of which the supporting arm absorbs energy. During the screwing process the supporting arm braces the screwdriver on the screwed connection. The supporting arm absorbs by deformation not only the energy occurring during the screwing process, but also the rotational energy remaining in the rotating masses, such as for example the electric motor and in particular the gear mechanism, after the power screwdriver has been switched off.

DE 196 20 782 A1 discloses a method for producing a screwed connection, in which the torque time curve is detected as a gradient. A distinction is drawn between a first and a second rise in torque, the first rise in torque being associated with a thread cutting process and the second rise in torque being associated with the tightening of the screwed connection. If the second torque gradient decreases, this is evaluated as being thread deformation and the screwdriver is switched off.

The invention is based on the object of disclosing a power screwdriver, in particular a battery-operated power screwdriver, which allows a specified desired torque value for a screwed connection to be reached without the risk of a torque overshoot.

The object is achieved by the features disclosed in the independent claim.

### DISCLOSURE OF THE INVENTION

The power screwdriver according to the invention has an electric motor as the drive, a desired torque specification element, an actual torque determination element, a torque gradient determination element and an electric motor activator which activates the electric motor as a function of the torque gradient. A torque threshold definition element is provided that provides a torque threshold value which is dependent on the torque gradient and lies below the desired torque value. If the actual torque value exceeds the torque threshold value, the electric motor activator specifies a speed reduction for the electric motor or already completely switches off the electric motor.

The power screwdriver according to the invention allows, based on the torque gradient determination element, a distinction to be drawn between hard and soft screwing cases. Owing to the determined torque gradient and the set desired torque value, the torque threshold definition element can purposefully define the torque threshold value so as to be below the desired torque value in such a way that a torque overshoot can be avoided as a result of the speed reduction or the complete switching-off of the electric motor after the torque threshold value has been exceeded.

Advantageous developments and embodiments of the power screwdriver according to the invention emerge from dependent claims.

One embodiment provides for the electric motor activator to specify the maximum possible speed of the electric motor for the electric motor in the case of an actual torque value lying below the torque threshold value. The maximum possible power is accordingly provided to the electric motor, the maximum possible speed being set under the given load conditions. This measure allows the screwed connection to be produced in the shortest possible time without the risk of a torque overshoot.

One embodiment provides for the torque threshold definition element to define the difference between the desired torque value and the torque threshold value as a function of the torque gradient. This measure takes account of the entire spectrum from soft to hard screwing cases. The torque threshold definition element sets the difference at a higher value at a higher torque gradient than at a lower torque gradient, so that a torque overshoot is avoided both in a hard and in a soft screwing case.

One embodiment provides for the torque threshold definition element to contain a table in which torque gradients and desired torque values are filed for defining the torque threshold value. Alternatively, provision may be made for the torque threshold definition element to extrapolate the torque threshold value based on the determined torque gradient, the actual torque value and the set desired torque value.

Another embodiment provides a motor current detector which detects the motor current as a measure of the actual torque value. The motor current detector may be embodied for example as a low-resistance shunt which can be produced more economically than an electromagnetic motor current detector.

Another embodiment provides a data carrier in which characteristic values of the screwed connection are stored and/or which is provided for storing collected data of the screwed connection to be produced. The data carrier contains at least the specified desired torque value. At least the actual torque value of the screwed connection that has actually been reached can be stored. The data carrier can furthermore contain characteristic variables, such as for example calibrated data of the power screwdriver, or be provided for storing characteristic variables of this type.

The data carrier may be associated with the power screwdriver. According to another embodiment, the power screwdriver has means for transmitting signals to a data carrier arranged outside the power screwdriver.

One development provides a voltage limiter circuit which limits the motor voltage occurring on the electric motor to a specified limiting voltage. The limiting voltage is preferably set at least to the nominal operating voltage of the electric motor, so that the electric motor can help to dissipate, by operating the electric motor in generator mode, energy which may be stored in a supporting arm of the power screwdriver toward the end of the screwing process without the electric motor applying a counter-torque.

The voltage limiter circuit preferably contains a bipolar limiter diode and/or a varistor.

Another development of the power screwdriver according to the invention provides, as the energy source for the electric motor, a lithium-based battery owing to its comparatively high energy density. Use may be made of, for example, a lithium ion battery (Li ion battery) or, for example, a lithium polymer battery (Li polymer battery).

If the supply voltage is provided by a battery, a battery voltage drop compensation circuit is preferably provided that compensates for the influence of a falling supply voltage on the reaching of the set desired torque value which occurs in particular if the actual torque value is obtained from the motor current. A simple embodiment of the battery voltage drop compensation circuit provides for the battery voltage drop compensation circuit to either increase the set desired torque value or reduce the determined actual torque value if the supply voltage falls. This avoids intervention in the power section of the electric motor.

Further advantageous embodiments and developments of the power screwdriver according to the invention will emerge from the following description. Exemplary embodiments of the power screwdriver according to the invention are illustrated in the drawings and described in greater detail in the following description.

In the drawings:

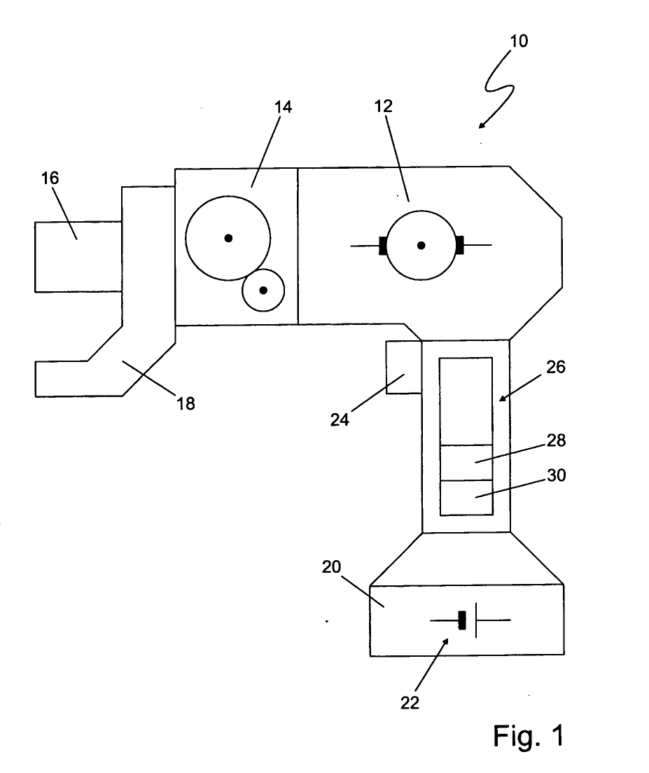

FIG. 1 is a sketch of a power screwdriver according to the invention;

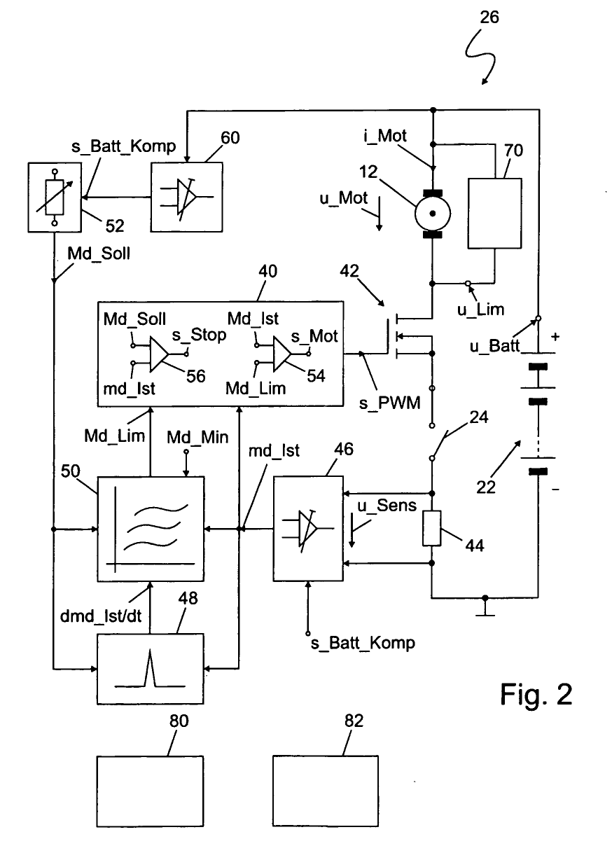

FIG. 2 is a block diagram of an activation circuit of the power screwdriver according to the invention;

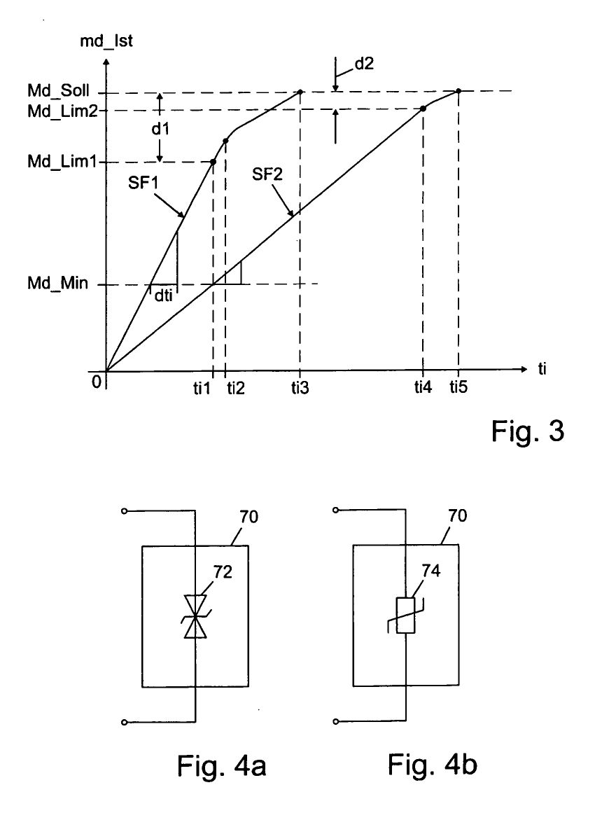

FIG. 3 shows torque curves as a function of time; and

FIGS. 4a and 4b show different embodiments of a voltage limiter circuit.

FIG. 1 is a sketch of a power screwdriver 10 containing an electric motor 12 as the drive which drives a socket 16 via a gear mechanism 14. The power screwdriver 10 contains a supporting arm 18 which provides a counter-torque during the screwing process. The starting point of the exemplary embodiment shown is a battery-operated power screwdriver 10 containing a battery part 20 in which a battery 22 is accommodated. The power screwdriver 10 is started up using a switch 24. An activation circuit 26, with which a data carrier 28 and a transmitting/receiving device 30 are associated, is provided for controlling the electric motor 12.

The starting point of the exemplary embodiment shown is a DC motor 12 which is preferably activated by a pulse width-modulated signal which defines the average operating voltage of the electric motor 12.

FIG. 2 shows an electric motor activator 40 which provides a pulse width-modulated signal s_PWM which either completely opens or completely closes a switching element 42, for example a MOS field effect transistor, wherein the period duration and/or the pulse duration may be variable.

The duty factor of the pulse width-modulated signal s_PWM, which reflects the ratio of the switch-on duration to the period duration, defines the average motor voltage u_Mot and allows, as a result, the power provided to the electric motor 12 or the speed of the electric motor 12 to be influenced.

After the switch 42 has been closed, a motor current i_Mot flows as a function of the duty factor of the pulse width-modulated signal s_PWM, as a function of the supply voltage u_Batt and as a function of the load of the electric motor 12.

The motor current i_Mot is adduced as a measure of the torque applied by the electric motor 12 and thus as a measure of the actual torque value provided to the socket 16. In the exemplary embodiment shown the motor current i_Mot is detected using a motor current detector 44 which is embodied as a resistor or shunt having a low resistance of, for example, 0.01 ohm. The voltage drop u_Sens, which occurs on the shunt 44 as a measure of the motor current i_Mot, is amplified in an actual torque determination element 46, containing for example an op amp wired as a differential amplifier, and provided as a measure of the actual torque value md_Ist. A signal smoothing device (not shown in greater detail), which frees the actual torque value md_Ist at least from high-frequency interfering signals, is preferably provided.

The actual torque value md_Ist is provided to the electric motor activator 40, a torque gradient determination element 48 and also a torque threshold definition element 50. The torque gradient determination element 48 determines the gradient dmd_Ist/dt of the actual torque value md_Ist by determining at least one time differential quotient. Preferably, the differential quotient is approximated by the difference quotient.

The torque gradient determination element 48 provides the torque gradient dmd_Ist/dt to the torque threshold definition element 50 which defines, based on the torque gradient dmd_Ist/dt, the actual torque value md_Ist, the desired torque value Md_Soll, which is provided by a desired torque specification element 52, and a minimum torque value Md_Min, a torque threshold value Md_Lim which is provided to the electric motor activator 40.

The definition of the torque threshold value Md_Lim in the torque threshold definition element 50 will be described in greater detail based on the torque time curves shown in FIG. 3. FIG. 3 shows a first screwing case SF1 corresponding to a hard screwing case in which a comparatively rapid change of the actual torque value md_Ist occurs. FIG. 3 shows a second screwing case SF2 corresponding to a soft screwing case in which a comparatively slow change of the actual torque value md_Ist occurs.

The torque gradient determination element 48 determines, after the beginning of the screwing process, the torque gradient dmd_Ist/dt which can be approximated, for example, by at least one difference quotient. The exemplary embodiment shown according to FIG. 3 assumes that the torque gradient determination element 48 determines at least one difference quotient, after the minimum torque value Md_Min has been exceeded, based on a time interval dti. The time interval dti is to be specified in such a way as to ensure, in the event of the anticipated most rapid possible rise in torque and at the lowest possible set desired torque value Md_Soll, that the torque threshold definition element 50 can determine and provide a torque threshold value MD_Lim1, Md_Lim2.

The minimum torque value Md_Min is for example set to an actual torque value md_Ist lying slightly above the anticipated joining moment of the screwed connection. With this measure it is possible to ensure that the actual torque gradient dmd_Ist/dt of the screwed connection is determined.

The torque threshold definition element 50 defines, in the first screwing case SF1, the first torque threshold value Md_Lim1 and, in the second screwing case SF2, the second torque threshold value Md_Lim2 based on the set desired torque value Md_Soll, the preferably specified minimum torque value Md_Min, the determined actual torque value md_Ist and also based on the torque gradient dmd_Ist/dt. The torque threshold values Md_Lim1, Md_Lim2 each lie below the desired torque value Md_Soll. The first torque threshold value Md_Lim1 lies a first difference d1 below the desired torque value Md_Soll and the second torque threshold value Md_Lim2 lies a second difference d2 below the desired torque value Md_Soll.

The torque threshold definition element 50 can define the threshold value Md_Lim1, Md_Lim2 based on filed tables. According to another exemplary embodiment, functional relationships between the aforementioned input variables are filed in the torque threshold definition element 50, so that the torque threshold values Md_Lim1, Md_Lim2 can be extrapolated starting from the current actual torque value md_Ist. The functional relationship may be based in the simplest case on a straight-line equation, so that the anticipated torque curve can be stipulated in its entirety as a result of the pitch and a point on the straight line. The torque threshold values Md_Lim1, Md_Lim2 or the functional relationships required for defining the threshold values Md_Lim1, Md_Lim2 are preferably determined experimentally and filed in the torque threshold definition element 50.

The first screwing case SF1 assumes that the first torque threshold value MD_Lim1 will have been reached by a first moment ti1. The first torque threshold value MD_Lim1 and the first difference d1 are adapted to a hard screwing case which was recognised based on the determined torque gradient dmd_Ist/dt. The first difference d1 is comparatively large.

The second screwing case SF2 assumes that the second torque threshold value Md_Lim2 will have been reached by a fourth moment ti4. The second torque threshold value Md_Lim2 and the second difference d2 are adapted to a soft screwing case which was recognised based on the determined torque gradient dmd_Ist/dt. The second difference d2 is comparatively small.

A first comparator 54 contained in the electric motor activator 40 compares the torque threshold value Md_Lim, Md_Lim1, Md_Lim2 to the actual torque value md_Ist and provides a control signal s_Mot as a function of the result of the comparison. The control signal s_Mot ensures that the pulse width-modulated signal s_PWM activates the electric motor 12 with a lower power than beforehand, so that a speed reduction is specified for the electric motor 12. Alternatively, provision may be made for the electric motor 12 to be completely switched off when the control signal s_Mot occurs.

The speed reduction or the complete switching-off after the torque threshold value Md_Lim, Md_Lim1, Md_Lim2 has been reached substantially prevents an overshoot of the actual torque value md_Ist that would lead to the screwed connection being screwed at a higher torque than the desired torque value Md_Soll.

The overshoot is caused by the kinetic energy present in the electric motor 12, and in particular in the gear mechanism 14, toward the end of the screwing process. The hard screwing case SF1 is particularly critical in this regard, because the desired torque value Md_Soll is reached in a comparatively short time ti. The exemplary embodiment shown in FIG. 3 assumes, to illustrate the problems, that, despite the speed reduction or the complete switching-off of the electric motor 12 after the first torque threshold value Md_Lim1 has been exceeded, the actual torque value md_Ist rises up to a second moment ti2 almost without reduction of the torque gradient dmd_Ist/dt. The speed reduction, which is caused by the control signal s_Mot and specified by the pulse width-modulated signal s_PWM, or the complete switching-off of the electric motor 12 accordingly takes effect only from the second moment ti2.

The desired torque value Md_Soll is reached at a third moment ti3 with a reduced torque gradient dmd_Ist/dt. If the electric motor 12 was not already completely switched off on exceeding of the first torque threshold value Md_Lim1, switching-off of the electric motor 12 is provided at the latest at the third moment ti3. This switching-off is caused by a stop signal s_Stop provided by a second comparator 56, which is arranged in the electric motor activator 40, as a function of the result of the comparison between the desired torque value Md_Soll and the actual torque value md_Ist.

In the soft screwing case SF2, in contrast to the hard screwing case SF1, a comparatively longer period is available, after the second torque threshold value Md_Lim2 has been reached, until the desired torque value Md_Soll is reached. Therefore, the second torque threshold value Md_Lim2 may be much closer to the desired torque value Md_Soll, in accordance with a smaller difference d2. In this case too, after the second torque threshold value Md_Lim2 has been reached, the speed reduction of the electric motor 12 is caused or the electric motor 12 is already completely switched off. Owing to the reduction, resulting therefrom, of the torque gradient dmd_Ist/dt, after the second torque threshold value Md_Lim2 has been exceeded, an overshoot is prevented also in the soft screwing case SF2, so that the screw joint is tightened exactly with the desired torque value Md_Soll which is reached at a fifth moment ti5.

The exemplary embodiment shown assumes that the battery 22, which is preferably embodied as a lithium-based battery which is distinguished by high energy density, is used for supplying energy to the electric motor 12. Use may be made of, for example, a lithium ion battery (Li ion battery) or, for example, a lithium polymer battery (Li polymer battery). The battery 22 provides the supply voltage u_Batt. Although the discharge characteristic curve of a battery, in particular a lithium-based battery, runs relatively flat, even a small voltage drop has a direct effect on the reaching of the desired torque value Md_Soll if the motor current i_Mot is adduced as a measure of the actual torque value md_Ist, as a lower motor current i_Mot is set as the supply voltage u_Batt falls.

A battery voltage drop compensation circuit 60 is therefore provided that compensates for the influence of a falling supply voltage u_Batt on the reaching of the set desired torque value Md_Soll.

In principle, the supply voltage u_Batt could be immediately stabilised and kept constant, although this would require power semiconductor components which on the one hand are relatively cost-intensive and on the other hand are, owing to the high anticipated currents of up to, for example, 100 A, too bulky to be able to be accommodated in the power screwdriver 10.

The battery voltage drop compensation circuit 60 therefore intervenes in the desired torque specification element 52 or in the actual torque determination element 46, preferably by means of a compensation signal s_Batt_Komp, either the desired torque value Md_Soll being increased or the actual torque value md_Ist being reduced as the supply voltage u_Batt falls.

The battery voltage drop compensation circuit 60 can for example contain a reference voltage source to which the supply voltage u_Batt is compared. As the difference between the reference voltage and the supply voltage u_Batt becomes smaller during the process of discharging the battery 22, the compensation signal s_Batt_Komp is constantly increased, the increase corresponding to a virtual reduction of the motor current i_Mot in order to compensate in the signal evaluation for the actually lower motor current i_Mot as the supply voltage u_Batt falls.

During operation of the power screwdriver 10, the supporting arm 18 provides the required counter-torque to the torque transmitted from the socket 16 to the screw joint. The supporting arm 18 should be fixed to a suitable support for preparing the screwing process. During the screwing process there occurs, as a function of the increasing torque, correspondingly increasing deformation of the supporting arm 18 that corresponds to storage of energy. The energy stored in the supporting arm 18 has, after the power screwdriver 10 has been switched off on reaching the set desired torque value Md_Soll, the maximum value.

As a result of the deformation of the supporting arm 18, the socket 16, and thus the power screwdriver 10 as a whole, is braced on the screwed connection. After the electric motor 12 has been switched off, the energy stored in the supporting arm 18 causes the electric motor 12 to be driven, starting from the socket 16, backward via the gear mechanism 14, wherein the electric motor 12 begins to rotate in the opposite direction to the direction of drive.

The electric motor 12 is therefore operated as a generator during the dissipation of the energy stored in the supporting arm 18. For rapid and simple dissipation of the energy stored in the supporting arm 18, the electric motor 12 should be able to rotate freely, without applying a counter-torque which would hinder and lengthen the discharging process. The electric motor 12 should therefore not be short-circuited or bridged with low resistance in this operating state, wherein a high motor current i_Mot, corresponding to a high counter-torque, would occur even at a low generator voltage. It should be borne in mind in this case that, in generator mode, the polarity of the motor voltage u_Mot is reversed, owing to the different direction of rotation, and the motor current i_Mot therefore flows in the opposite direction, provided that the flow path is available.

In particular, tests have revealed that, in generator mode, considerable motor voltages u_Mot can occur lying well above the nominal operating voltage of the electric motor 12. In an electric motor 12 having a nominal operating voltage of, for example, 28 volts, voltage peaks of up to above 200 volts having a pulse duration of several hundred ns were demonstrated. Such high-energy pulses can lead to the destruction of components of the activation circuit 26, in particular to the destruction of the switching element 42.

The voltage limiter circuit 70 is therefore provided that limits the motor voltage u_Mot, occurring on the electric motor 12, of the electric motor 12, which is operated as a generator during the dissipation of the energy stored in the supporting arm 18 and rotates counter to the direction of drive, to a specified limiting voltage u_Lim.

The voltage limiter circuit 70 is not comparable to a free-wheeling element which substantially short-circuits merely the electric motor 12. The voltage limiter circuit 70 allows the limiting voltage u_Lim to be specified in a targeted manner, so that the electric motor 12 does not generate any counter-torque during generator operation, on the destruction of the energy stored in the supporting arm 18, at least until the limiting voltage u_Lim has been reached. In this operating state a motor current i_Mot occurs in the opposite direction compared to normal operation only if the motor voltage u_Mot attempts, in generator mode, to exceed the limiting voltage u_Lim.

Nevertheless, the voltage limiter circuit 70 can assume the function of a free-wheeling element, the limiting voltage u_Lim occurring as the motor voltage u_Mot during the free-wheeling in which the direction of the motor current i_Mot is not reversed. If appropriate, a switched free-wheeling element (not shown in greater detail) may be provided that is activated by the pulse width-modulated signal s_PWM.

The voltage limiter circuit 70 can be embodied in different ways. In the exemplary embodiment shown in FIG. 4a the voltage limiter circuit 70 contains a bipolar voltage limiter diode 72 which is also referred to as a TVS (transient voltage suppressor). The voltage limiter diode 72 contains two Zener diodes integrated in a single component. In the exemplary embodiment shown in FIG. 4b the voltage limiter circuit 70 contains a varistor 74.

While diodes 72 allow very rapid reaction to voltage pulses, a varistor 74 can absorb and discharge more energy, at least in the short term. A combination of diodes 72 and also a varistor 74 may therefore be provided as required.

The limiting voltage u_Lim is first set to a value at which no limitation of the motor voltage u_Mot can occur in normal drive mode. The limiting voltage u_Lim is accordingly set, in the case of a 28-volt electric motor 12, to a value of at least 28 volts. As the motor voltage u_Mot is reversed in the generator mode of the electric motor 12, the voltage limiter circuit 70 has to provide the limiting voltage u_Lim, in particular for the motor voltage u_Mot at reversed polarity, as there is the risk of overvoltage, in particular in generator mode. In the exemplary embodiment shown, with the polarity of the supply voltage u_Batt entered in FIG. 2, the positive potential of the motor voltage u_Mot occurs, in the generator mode of the electric motor 12, on the switching element 42, while the negative potential is applied to the battery 22.

Expediently, a limiting voltage u_Lim is specified that corresponds at least to the amount of the nominal operating voltage of the electric motor 12. According to another embodiment, at least the limiting voltage u_Lim, which is operative in the generator mode of the electric motor 12, is set to the value of what is known as a protective extra-low voltage which may be defined by law. A protective extra-low voltage in this sense should be defined in that, on an electrical apparatus, in the present case the power screwdriver 10, live parts, which can be contacted, may not exceed the protective extra-low voltage. If this might be the case, special measures must be taken for protection against accidental contact. The protective extra-low voltage is for example at 42 volts.

Another development of the power screwdriver 10 according to the invention provides a data carrier 80 containing data for the screw joint, such as for example at least the desired torque value Md_Soll, and/or for recording data, such as for example the actual torque value md_Ist which has actually been reached, which are stored at least at the end of the screwing process. The data carrier 80 can also contain calibrated data of the power screwdriver 10 and/or be prepared for storing characteristic variables of the power screwdriver 10. Preferably, the data carrier 80 is embodied as a mobile data carrier, for example as an inexpensively available RFID.

Another development of the power screwdriver 10 according to the invention provides means 82 for transmitting signals, for example a transmitting/receiving device 82 which is embodied for receiving and/or for transmitting data concerning the screw joint and/or concerning characteristic variables of the power screwdriver 10. The transmitting/receiving device 82 is preferably configured for interacting with a data carrier (not shown in greater detail), for example a mobile data carrier which may correspond to the data carrier 80. If this data carrier is an aforementioned RFID, the transmitting/receiving device 82 has a high-frequency transmitter and/or high-frequency receiver, wherein the transmitting/receiving frequency is to be adapted to the transmitting/receiving frequency of the data carrier.

1. Power screwdriver with an electric motor (12) as the drive, with a desired torque specification element (52) and with an actual torque determination element (46), with a torque gradient determination element (48) and with an electric motor activator (40) which activates the electric motor (12) as a function of the torque gradient (dmd_Ist/dt), wherein a torque threshold definition element (50) is provided, wherein the torque threshold definition element (50) provides a torque threshold value (Md_Lim, Md_Lim1, Md_Lim2) which is dependent on the torque gradient (dmd_Ist/dt) and lies below the desired torque value (Md_Soll), and wherein the electric motor activator (40) specifies a speed reduction for the electric motor (12) or completely switches off the electric motor (12) if the actual torque value (md_Ist) exceeds the torque threshold value (Md_Lim, Md_Lim1, Md_Lim2).

2. Power screwdriver according to claim 1, wherein the electric motor activator (40) specifies the maximum possible speed of the electric motor (12) for the electric motor (12) in the case of an actual torque value (md_Ist) lying below the torque threshold value (Md_Lim, Md_Lim1, Md_Lim2).

3. Power screwdriver according to claim 1, wherein the torque threshold definition element (50) defines the difference (d1, d2) between the desired torque value (Md_Soll) and the torque threshold value (Md_Lim, Md_Lim1, Md_Lim2) as a function of the torque gradient (dmd_Ist/dt).

4. Power screwdriver according to claim 3, wherein the torque threshold definition element (50) defines the difference (d1, d2) as being greater at a higher torque gradient (dmd_Ist/dt) than at a lower torque gradient (dmd_Ist/dt).

5. Power screwdriver according to claim 1, wherein the torque threshold definition element (50) contains a table in which torque gradients (dmd_Ist/dt) and desired torque values (Md_Soll) are filed for defining the torque threshold value (Md_Lim, Md_Lim1, Md_Lim2).

6. Power screwdriver according to claim 1, wherein the torque threshold definition element (50) extrapolates the torque threshold value (Md_Lim, Md_Lim1, Md_Lim2) based on the determined torque gradient (dmd_Ist/dt), the actual torque value (md_Ist) and the desired torque value (Md_Soll).

7. Power screwdriver according to claim 1, wherein a motor current detector (44) is provided that detects the motor current (i_Mot) as a measure of the actual torque value (md_Ist).

8. Power screwdriver according to claim 1, wherein a data carrier (80) is provided in which characteristic values of the screwed connection and/or the power screwdriver (10) are stored and/or which is provided for storing collected data of a screwed connection or characteristic values of the power screwdriver (10).

9. Power screwdriver according to claim 8, wherein the power screwdriver (10) has means (82) for transmitting signals to a data carrier arranged outside the power screwdriver (10).

10. Power screwdriver according to claim 1, wherein a voltage limiter circuit (70) is provided that limits the motor voltage (u_Mot) occurring on the electric motor (12) to a specified limiting voltage (u_Lim) which is set at least to the nominal operating voltage of the electric motor (12).

11. Power screwdriver according to claim 10, wherein the voltage limiter circuit (70) contains a bipolar limiter diode (72).

12. Power screwdriver according to claim 10, wherein the voltage limiter circuit (70) contains a varistor (74).

13. Power screwdriver according to claim 1, wherein a battery (22) is provided for providing the supply voltage (u_Batt).

14. Power screwdriver according to claim 13, wherein the battery (22) is a lithium-based battery (Li ion battery, Li polymer battery).

15. Power screwdriver according to claim 13, wherein a battery voltage drop compensation circuit (60) is provided that compensates for the influence of a falling supply voltage (u_Batt) on the reaching of the set desired torque value (Md_Soll).

16. Power screwdriver according to claim 15, wherein the battery voltage drop compensation circuit (60) increases the set desired torque value (Md_Soll) or reduces the determined actual torque value (md_Ist) if the supply voltage (u_Batt) falls.
